(19) United States
(12) Patent Application Publication
(10) Pub. No.: US 2013/0250159 A1
(43) Pub. Date: Sep. 26, 2013

(54) IMAGE CAPTURING APPARATUS

(71) Applicant: CASIO COMPUTER CO., LTD., Tokyo (JP)

(72) Inventor: Tomoaki NAGASAKA, Tokyo (JP)

(73) Assignee: CASIO COMPUTER CO., LTD., Tokyo (JP)

(21) Appl. No.: 13/797,709

(22) Filed: Mar. 12, 2013

(30) Foreign Application Priority Data
Mar. 21, 2012 (JP) 2012-064534

(51) Int. Cl. H04N 5/225

(52) U.S. Cl. CPC H04N 5/2254
USPC 348/340

(57) ABSTRACT

An image capturing apparatus 1 includes: an image capturing element 41; a main lens 21 that condenses light from an object in a direction toward the image capturing element 41; and a micro-lens array 31 composed of a plurality of micro lenses being arranged between the image capturing element 41 and the main lens 21, and forming an image on the image capturing element 41 from the light having passed through the main lens 21. The micro-lens array 31 is composed of several types of micro lenses 31A, 31B and 31C with different focal distances. Distribution morphology of the micro lens 31A that is at least one type of the several types is different from distribution morphology of the other types of micro lenses 31B and 31C.

This application is based on and claims the benefit of priority from Japanese Patent Application No. 2012-064534, filed on 21 Mar. 2012, the content of which is incorporated herein by reference.

### BACKGROUND OF THE INVENTION

1. Field of the Invention

The present invention relates to an image capturing apparatus.

2. Related Art

In recent years, a plenoptic camera is proposed, which is an image capturing apparatus that takes information regarding direction distribution of incident rays (for example, see Patent Document 1: Japanese Unexamined Patent Application (Translation of PCT Application), Publication No. 2009-532993).

A micro-lens array is disposed in the plenoptic camera. The micro-lens array is composed of a plurality of extremely small lenses (hereinafter referred to as “micro lenses”) that are arranged in a lattice-like manner between an image capturing element and a main lens that is a conventional imaging lens.

The individual micro lenses composing the micro-lens array condense light, which was condensed by the main lens, toward a plurality of pixels in the image capturing element in accordance with angles of the light that arrived. The plenoptic camera generates a captured image (hereinafter referred to as “light field image”) by synthesizing images (hereinafter referred to as “sub-images”) from the light condensed by the individual micro lenses onto the individual pixels in the image capturing element.

In this way, the light field image is generated not only from the light entering through the conventional main lens, but also from the light entering through the micro-lens array. In other words, in addition to two-dimensional space information that is included in a conventional captured image, the light field image includes two-dimensional direction information indicating a direction of a ray that arrives at the image capturing element, as information that is not included in the conventional captured image.

By utilizing such two-dimensional direction information, and by using data of a light field image after capturing the light field image, the plenoptic camera can reconstruct an image of a plane that was separated at an arbitrary distance ahead when the image was captured. In other words, even in a case in which a light field image is captured without being focused on a predetermined distance, the plenoptic camera can freely create data of an image as if the image was captured by being focused on the predetermined distance (hereinafter referred to as “reconstructed image”) by using the data of the light field image after capturing the image.

More specifically, the plenoptic camera sets a point in a plane at an arbitrary distance as an attention point, and calculates which pixel in the image capturing element the light is distributed from the attention point through the main lens and the micro-lens array.

Here, for example, if pixels of the image capturing element correspond to pixels composing the light field image, respectively, the plenoptic camera calculates an average of pixel values of one or more pixels to which the light is distributed from the attention point, among the pixels composing the light field image. In the reconstructed image, the calculated value serves as a pixel value of a pixel corresponding to the attention point. In this manner, the pixel corresponding to the attention point is reconstructed in the reconstructed image.

The plenoptic camera sequentially sets pixels corresponding to points in the plane at the arbitrary distance (pixels composing the reconstructed image) as attention points, respectively, and repeats the series of processing, thereby generating data of the reconstructed image (collection of the pixel values of the pixels of the reconstructed image).

Incidentally, in a conventional plenoptic camera as shown in FIG. 16, micro lenses of a single type compose a micro-lens array, and correspond to the entire range of focal points. As a result, depending on values such as an object distance and a focal distance of the micro-lens, a blur (micro lens blur) of the micro lens is increased, which then prevents a high-definition reconstructed image from being generated based on a captured light field image.

A plenoptic camera is used by various users with various tendencies, such as a user who is more likely to photograph a distant view, a user who is more likely to photograph a view with a person(s), an animal(s) and/or a plant(s) being set in the center of a field angle, and a user who is more likely to photograph a close view. However, since a conventional plenoptic camera configures a micro-lens array by micro lenses of a single type, in a case in which a user has a strong tendency as described above, a micro lens blur may be increased, and there is a possibility that a high-definition reconstructed image cannot be obtained.

### SUMMARY OF THE INVENTION

A first aspect of the present invention is an image capturing apparatus that includes: an image capturing element; a main lens that condenses light from an object in a direction toward the image capturing element; and a micro-lens array that is composed of a plurality of micro lenses being arranged between the image capturing element and the main lens, and forming an image on the image capturing element from the light having passed through the main lens, in which the micro-lens array is composed of a plurality of types of micro lenses with different focal distances, and distribution morphology of at least one type of the plurality of types of micro lenses is different from distribution morphology of other types of the micro lenses.

A second aspect of the present invention is an image capturing apparatus that is configured by: an image capturing unit including an image capturing element; a main lens unit, which is configured to be detachable from the image capturing unit, and which includes a main lens that condenses light from an object in a direction toward the image capturing element; and a micro-lens array unit including a micro-lens array that is composed of a plurality of micro lenses, the micro-lens array being detachably arranged between the image capturing unit and the main lens unit, and forming an image on the image capturing element from light having passed through the main lens, in which the image capturing apparatus further includes a lens position adjustment unit that adjusts a position of the main lens or the micro-lens array by moving the main lens or the micro-lens array to a position where sizes of micro lens blurs are minimized, in a case in which the micro-lens array unit is mounted between the image capturing unit and the main lens unit.

### BRIEF DESCRIPTION OF THE DRAWINGS

FIGS. 1A and 1B are diagrams showing a configuration of an image capturing apparatus according to the present embodiment;

FIGS. 2A and 2B are diagrams showing a configuration of the micro-lens array that composes the image capturing apparatus;

FIGS. 3A and 3B are diagrams in a case in which the micro-lens array unit that composes the image capturing apparatus is visually observed from an optical axis direction;

FIGS. 4A and 4B are schematic diagrams showing an optical system configuration in the image capturing apparatus;

FIG. 5 is a diagram showing an example of sub-images in a case in which the micro-lens array is used in the image capturing apparatus;

FIG. 6 is a control block diagram (part 1) in the image capturing apparatus;

FIG. 7 is a diagram illustrating an aspect, in which light from an attention point is distributed to a pixel in an image capturing element in the image capturing apparatus;

FIG. 8 is a diagram illustrating calculation of a size of a micro lens blur that occurs in the image capturing apparatus;

FIGS. 9A and 9B are diagrams showing states before and after adjusting a principal plane of a main lens in the image capturing apparatus;

FIGS. 10A, 10B and 10C are diagrams showing sub-images that are formed on the image capturing element by micro lenses in a case in which a diaphragm mechanism of the main lens in the image capturing apparatus is adjusted;

FIG. 11 is a diagram illustrating calculation of an optimum F-number of the main lens in the image capturing apparatus;

FIG. 12 is a control block diagram (part 2) in the image capturing apparatus;

FIGS. 13A and 13B are diagrams showing an example of adjusting a blur size and a sub-image size by adjusting a position of the micro-lens array in the image capturing apparatus;

FIG. 14 is a diagram illustrating calibration in the image capturing apparatus;

FIG. 15 is a flowchart showing a flow of reconstruction processing in the image capturing apparatus; and

FIG. 16 is a schematic diagram showing a configuration example of an optical system in an image capturing unit that composes a conventional plenoptic camera.

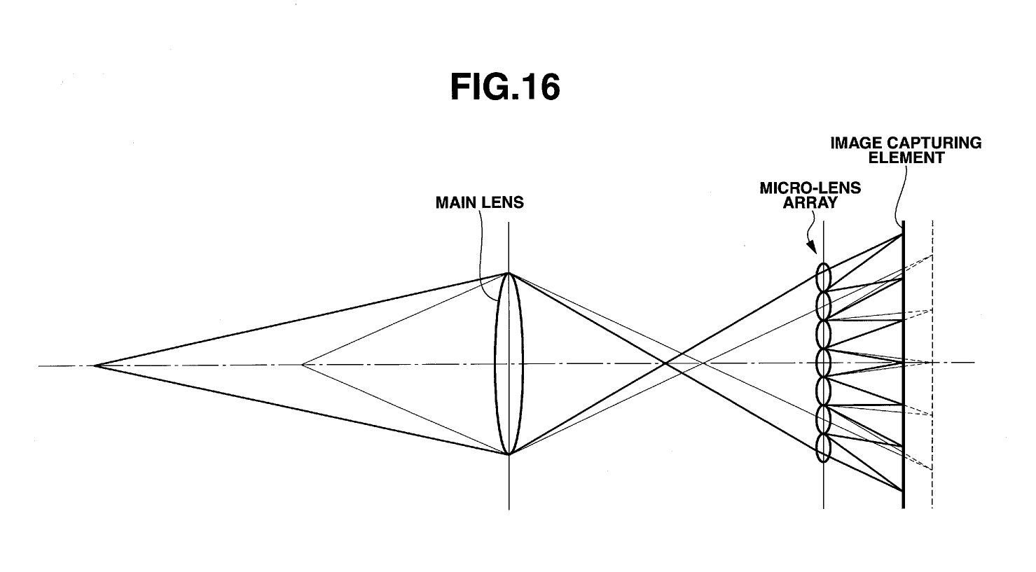

### DETAILED DESCRIPTION OF THE INVENTION

An embodiment of the present invention is hereinafter described with reference to the drawings.

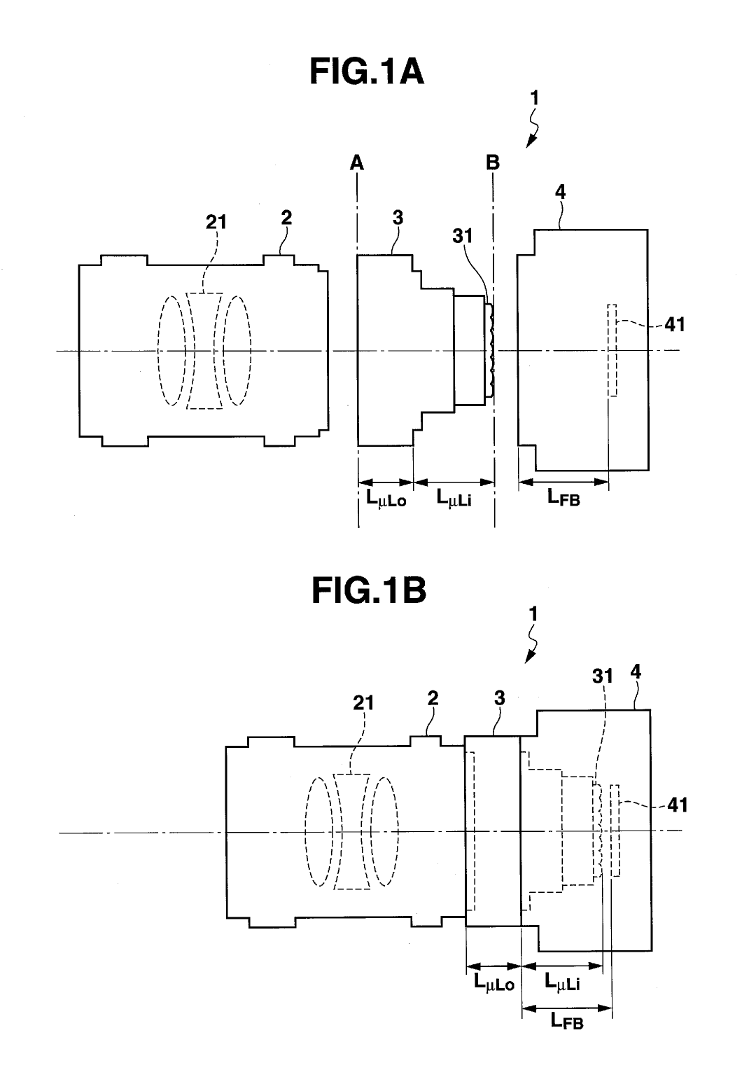

FIGS. 1A and 1B are diagrams showing a configuration of an image capturing apparatus according to the present embodiment.

FIG. 1A is a diagram showing a state where each lens unit is not mounted to an image capturing unit that configures the image capturing apparatus. FIG. 1B is a diagram showing a state where each lens unit is mounted to the image capturing unit that configures the image capturing apparatus.

As shown in FIGS. 1A and 1B, the image capturing apparatus 1 is configured by a main lens unit 2, a micro-lens array unit 3, and an image capturing unit 4.

The main lens unit 2 internally includes an optical system that includes a main lens 21 and a diaphragm mechanism (not illustrated) that controls quantity of light that enters through the main lens 21. For the purpose of capturing an image of an object, the main lens 21 is configured by a lens such as a focus lens and a zoom lens for condensing light. The focus lens forms an image of an object on a light receiving surface of an image capturing element 41 (to be described later). The zoom lens freely changes its focal length within a certain range. The main lens unit 2 has a mounting structure that can be concurrently mounted to the micro-lens array unit 3 and the image capturing unit 4.

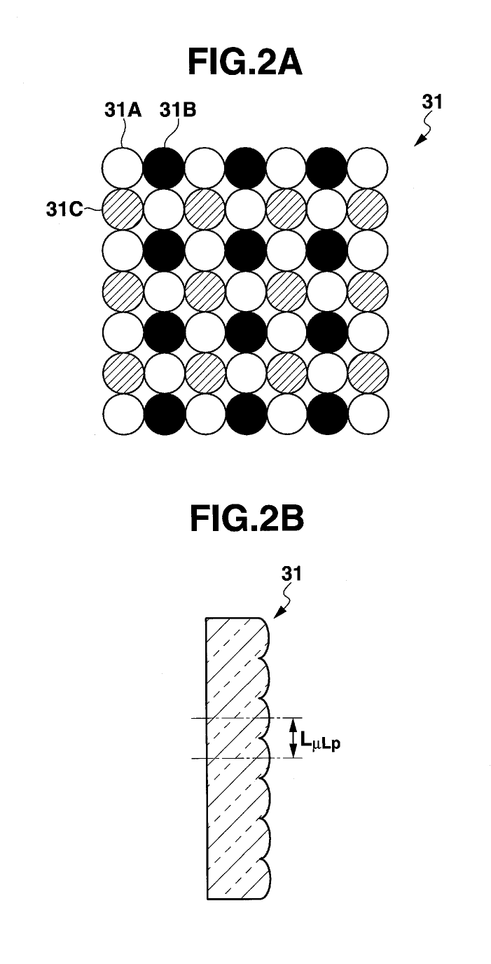

The micro-lens array unit 3 includes a micro-lens array 31 on an end portion, to which the image capturing unit 4 is mounted. FIGS. 2A and 2B are diagrams showing a configuration of the micro-lens array 31. More specifically, FIG. 2A is a front view of the micro-lens array 31; and FIG. 2B is a cross-sectional view of the micro-lens array 31. As shown in FIG. 2A, the micro-lens array 31 is composed of several types of micro lenses 31A, 31B and 31C. The several types of micro lenses 31A, 31B and 31C have different focal distances, respectively, and form an image on the image capturing element 41 (to be described later) from the light that has passed through the main lens 21.

As shown in FIG. 2A, the number of the several types of micro lenses 31A, 31B and 31C as provided is different for each type. In FIG. 2A, the micro lens 31A, the micro lens 31B and the micro lens 31C are arranged at a ratio of 2:1:1. In other words, the micro-lens array 31 has a matrix structure, in which the micro lens 31A and the micro lens 31B are alternately arranged in a horizontal line, the micro lens 31C and the micro lens 31A are alternately arranged in an adjacent horizontal line, and the lines are alternately repeated in a vertical direction. In the lines, the micro lenses 31A are arranged so as not to be adjacent in the vertical direction (in other words, arranged in a zigzag).

In the present embodiment, the several types of micro lenses 31A, 31B and 31C are equally arranged; however, the present invention is not limited thereto. For example, the several types of micro lenses may be unequally arranged in each area of the micro-lens array 31. In other words, distribution of arranging the several types of micro lenses may be made different between the center and the periphery of the micro-lens array 31. In this case, for example, a larger number of micro lenses corresponding to short distances may be arranged in the vicinity of the center of the micro-lens array 31, and a larger number of micro lenses corresponding to long distances may be arranged in the periphery of the micro-lens array 31.

As shown in FIGS. 2A and 2B, the micro lenses are arranged to be equally distributed in the micro-lens array 31. Here, a distance between central positions of adjacent micro lenses is referred to as a micro lens pitch LμLp.

With reference to FIGS. 1A and 1B again, a micro-lens outside distance LμLo and a micro-lens inside distance LμLi are defined in the micro-lens array unit 3. As shown in FIG. 1B, in a case in which the main lens unit 2 and the micro-lens array unit 3 are mounted to the image capturing unit 4, the micro-lens outside distance LμLo is a distance in an optical axis direction of an exposed portion. As shown in FIG. 1B, in a case in which the main lens unit 2 and the micro-lens array unit 3 are mounted to the image capturing unit 4, the micro-lens inside distance LμLi is a distance in the optical axis direction of a portion where the micro-lens array unit 3 is fitted into the image capturing unit 4.

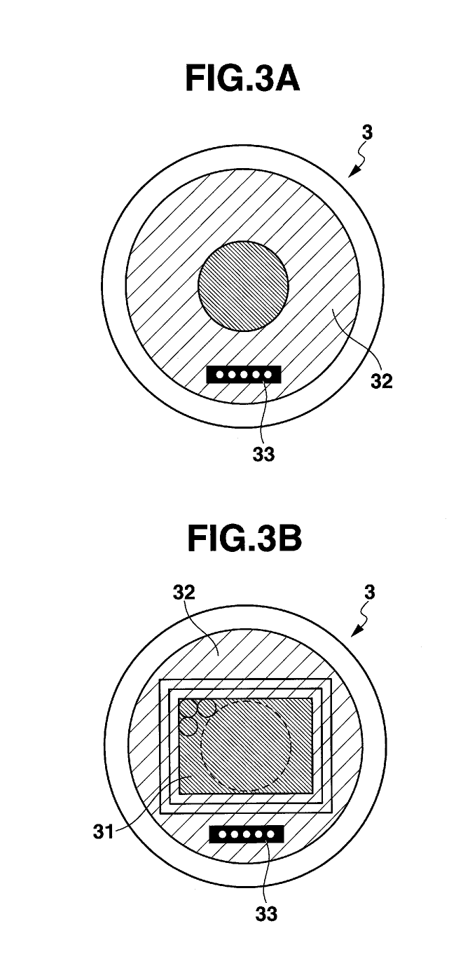

FIGS. 3A and 3B are diagrams in a case in which the micro-lens array unit 3 is visually observed from the optical axis direction. More specifically, FIG. 3A is a diagram in a case in which the micro-lens array unit 3 is visually observed from a plane A (shown in FIG. 1A) on the main lens unit 2 side; and FIG. 3B is a diagram in a case in which the micro-lens array unit 3 is visually observed from a plane B (shown in FIG. 1A) on the image capturing unit 4 side.

As shown in FIGS. 3A and 3B, the micro-lens array unit 3 includes an electric contact 33 in a lower portion of a lens barrel 32. In a case in which the main lens unit 2 and the micro-lens array unit 3 are mounted to the image capturing unit 4, the electric contact 33 can be connected to an electric contact (not illustrated) provided to the main lens unit 2, and can be connected to an electric contact (not illustrated) provided to the image capturing unit 4. As a result, the main lens unit 2, the micro-lens array unit 3 and the image capturing unit 4 are electrically connected to one another.

With reference to FIGS. 1A and 1B again, the image capturing unit 4 includes the image capturing element 41 in the center of the bottom of the housing that faces the opening (mount) where the main lens unit 2 or the micro-lens array unit 3 is mounted. The image capturing element 41 is configured by, for example, photoelectric conversion element of a CMOS (Complementary Metal Oxide Semiconductor) type, etc. An object image enters the photoelectric conversion element through the main lens 21 or each of the micro lenses. The photoelectric conversion element then photo-electrically converts (captures) the object image, accumulates an image signal thereof for a certain period of time, and sequentially supplies the accumulated image signal as an analog signal to an AFE (not illustrated).

The AFE executes a variety of signal processing such as A/D (Analog/Digital) conversion processing on the analog electric signal. A digital signal is generated by a variety of signal processing, and is output as an output signal to an image capturing control unit (to be described later).

In the image capturing unit 4, a distance between a face connected to the micro-lens array unit 3 and a surface of the image capturing element 41 is referred to as a flange back (flange focus) LFB.

Next, descriptions are provided for difference between a case in which the main lens unit 2 and the micro-lens array unit 3 are mounted to the image capturing unit 4, and a case in which the main lens unit 2 is directly mounted to the image capturing unit 4.

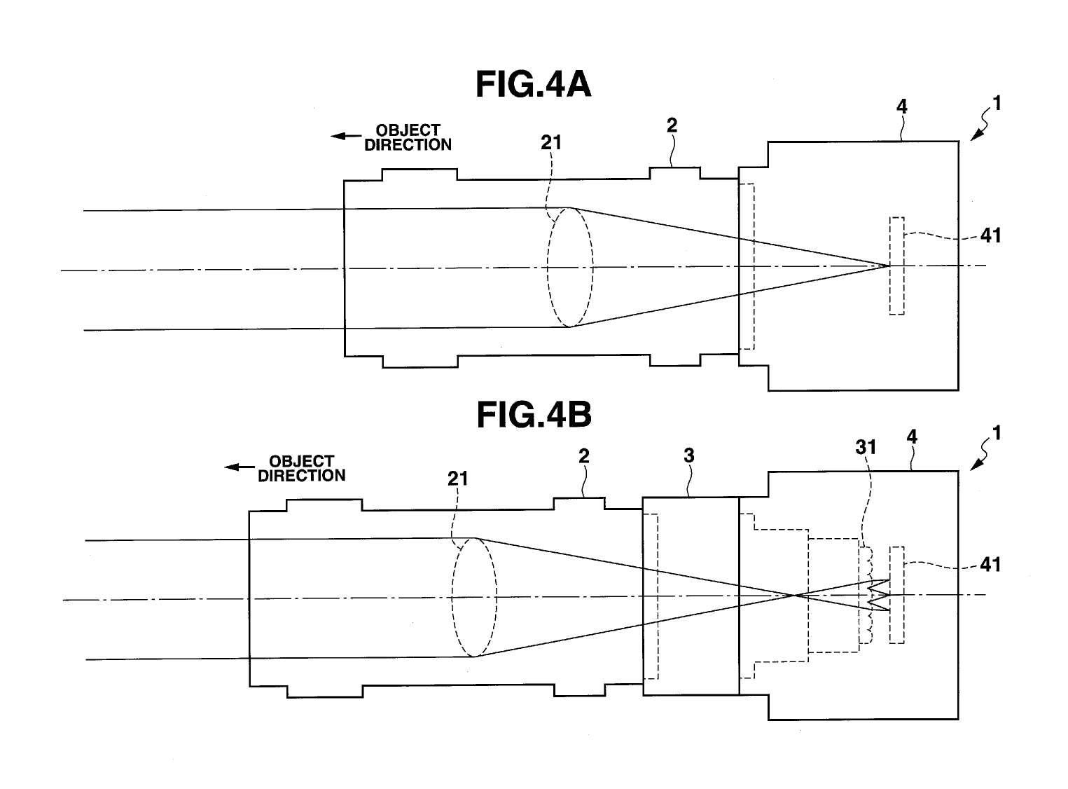

FIGS. 4A and 4B are schematic diagrams showing an optical system configuration in the image capturing apparatus 1. More specifically, FIG. 4A is a schematic diagram showing an optical system configuration in a case in which only the main lens unit 2 is mounted to the image capturing unit 4. FIG. 4B is a schematic diagram showing an optical system configuration in a case in which the main lens unit 2 and the micro-lens array unit 3 are mounted to the image capturing unit 4.

As shown in FIGS. 4A and 4B, when light is emitted from an object, and enters through the lens barrel of the main lens unit 2, the main lens 21 condenses the light toward the image capturing element 41, and forms an image on the image capturing element 41. As shown in FIG. 4A, in a case in which only the main lens unit 2 is mounted to the image capturing unit 4, the light condensed by the main lens 21 forms a single image on the surface of the image capturing element 41.

On the other hand, as shown in FIG. 4B, in a case in which the main lens unit 2 and the micro-lens array unit 3 are mounted to the image capturing unit 4, the light condensed by the main lens 21 is focused frontward of the micro-lens array 31, and then enters through the micro-lens array 31. Each of the plurality of micro lenses 31A, 31B and 31C that compose the micro-lens array 31 condenses the entering light, and forms a sub-image on the image capturing element 41. As a result, as an ensemble of the sub-images formed by the plurality of micro lenses 31A, 31B and 31C, a light field image is generated on the image capturing element 41. An image capturing control unit 46 (to be described later) generates a reconstructed image by using the light field image.

Here, the plurality of micro lenses 31A, 31B and 31C that compose the micro-lens array 31 have different focal distances, respectively. Therefore, in a case in which light condensed by a certain type of micro lens forms an image on the surface of the image capturing element 41, light condensed by an other type of micro lens is focused frontward or backward of the image capturing element 41. As a result, a blur (micro lens blur) occurs in the sub-image formed on the capturing element 41 by the other type of micro lens.

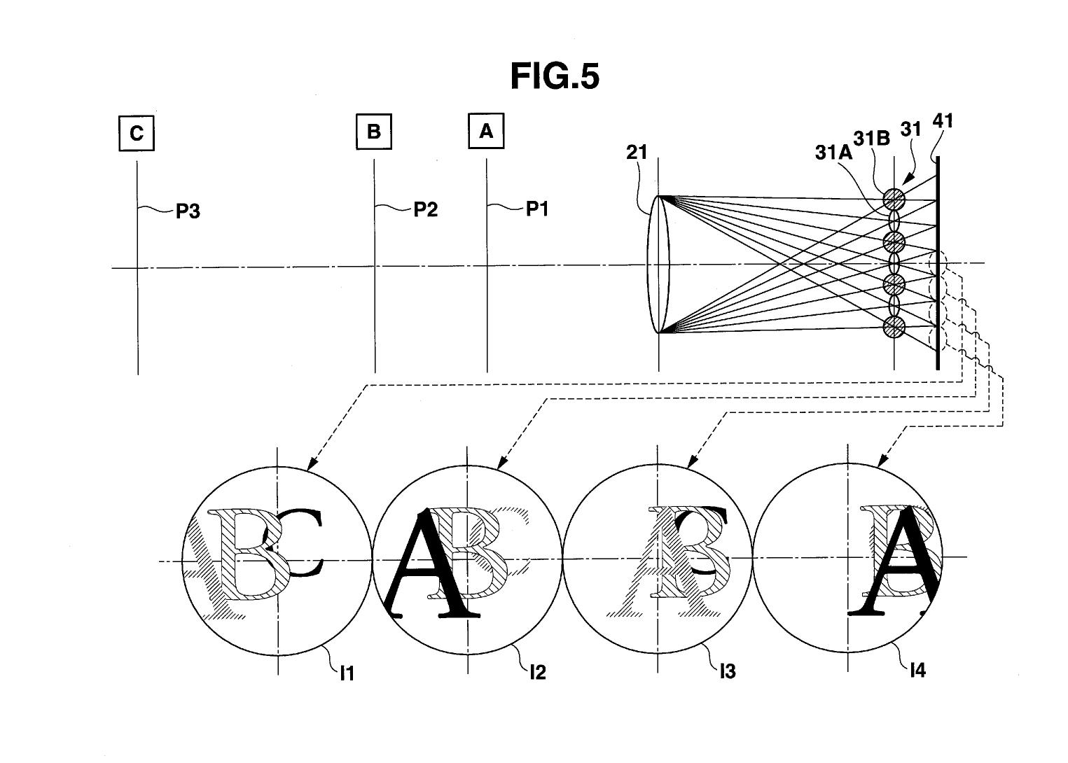

FIG. 5 is a diagram showing examples of sub-images in a case in which the micro-lens array 31 is used.

FIG. 5 shows sub-images I1, I2, I3 and I4, in a case in which transparent plates P1, P2 and P3 are arranged in ascending order of distance from the main lens 21.

Here, characters “A”, “B” and “C” are marked in the same color (for example, black) on the plates P1, P2 and P3, respectively.

The sub-images I1 and I3 are formed by the micro lens 31A. Here, the focal distance of the micro lens 31A is longer than the focal distance of the micro lens 31B, and the character “C” is marked on the plate P3 that is the furthest from the main lens 21; therefore, the character “C” is in focus. As a result, in the sub-images I1 and I3, the character “C” is displayed more clearly than the other characters.

The sub-images 12 and 14 are formed by the micro lens 31B. Here, the focal distance of the micro lens 31B is shorter than the focal distance of the micro lens 31A, and the character “A” is marked on the plate P1 that is the closest to the main lens 21; therefore, the character “A” is in focus. As a result, in the sub-images I2 and I4, the character “A” is displayed more clearly than the other characters.

The characters are displayed in different positions in the sub-images I1 to I4, respectively. This occurs due to parallax of objects (here, the characters “A”, “B” and “C”) as a result of arranging the micro lenses in different positions.

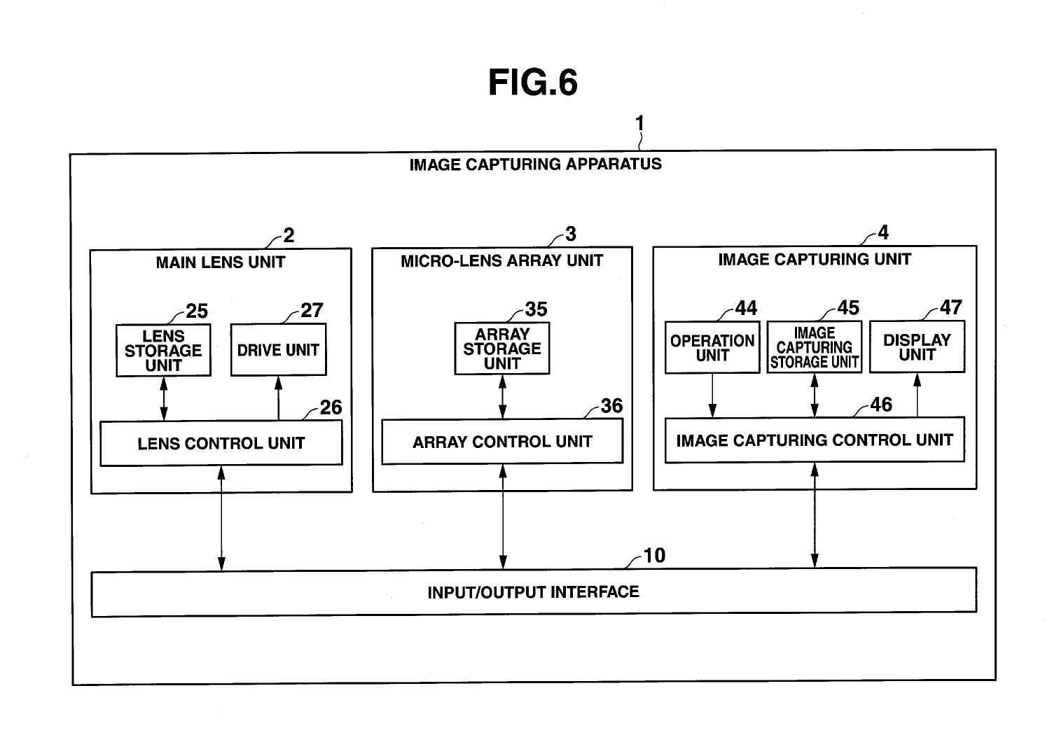

Next, descriptions are provided for control in the image capturing apparatus 1. FIG. 6 is a control block diagram for the image capturing apparatus 1. Illustrations and descriptions of the components that have been described in FIG. 1A to 3B are omitted in FIG. 6.

The main lens unit 2, the micro-lens array unit 3 and the image capturing unit 4 are connected by an input/output interface 10. The input/output interface 10 is configured by the electric contact 33, etc. described above, and enables communication among the main lens unit 2, the micro-lens array unit 3 and the image capturing unit 4.

The main lens unit 2 includes a lens storage unit 25, a lens control unit 26, and a drive unit 27.

The lens storage unit 25 is configured by ROM (Read Only Memory), RAM (Random Access Memory), etc., and stores various programs, data, etc. for controlling the main lens unit 2. The lens storage unit 25 stores the focal distance of the main lens 21 in advance.

The lens control unit 26 is configured by a CPU (Central Processing Unit), and executes various processing in accordance with the programs stored in the lens storage unit 25 and various instructions received from the image capturing unit 4. More specifically, when the lens control unit 26 receives a control signal from the image capturing unit 4 via the input/output interface 10, the lens control unit 26 transmits the focal distance of the main lens 21 stored in the lens storage unit 25 to the image capturing unit 4. When the lens control unit 26 receives a signal for adjusting the position of the main lens 21 from the image capturing unit 4, the lens control unit 26 controls the drive unit 27 to adjust the position of the main lens 21.

The drive unit 27 is configured by peripheral circuits and a diaphragm mechanism for adjusting configuration parameters such as a focal point, an exposure and a white balance of the main lens 21, and adjusts the position of the main lens 21 and adjusts the diaphragm mechanism in accordance with the control by the lens control unit 26.

The micro-lens array unit 3 includes an array storage unit 35 and an array control unit 36.

The array storage unit 35 is configured by ROM, RAM, etc., and stores data, etc. for the micro-lens array 31 and each of the micro lenses. The array storage unit 35 stores in advance the micro-lens outside distance LμLo, the micro-lens inside distance LμLi, the micro-lens focal distance for each type, and the micro lens pitch LμLp.

The array control unit 36 is configured by a CPU, etc., and transmits a variety of data stored in the array storage unit 35 to the image capturing unit 4, in accordance with various instructions received from the image capturing unit 4. More specifically, when the array control unit 36 receives a control signal from the image capturing unit 4 via the input/output interface 10, the array control unit 36 transmits the micro-lens outside distance LμLo, the micro-lens inside distance LμLi, the micro-lens focal distance for each type and the micro lens pitch LμLp stored in the array storage unit 35 to the image capturing unit 4.

The image capturing unit 4 includes an operation unit 44, an image capturing storage unit 45, an image capturing control unit 46, and a display unit 47.

The operation unit 44 is configured by various buttons such as a shutter button (not illustrated), and inputs a variety of information in accordance with instruction operations by a user.

The image capturing storage unit 45 is configured by ROM, RAM, etc., and stores various programs, data, etc. for controlling the image capturing unit 4. The image capturing storage unit 45 stores the flange back (flange focus) LFB in advance. The image capturing storage unit 45 stores data of various images such as a light field image and a reconstructed image captured by the image capturing apparatus 1.

The display unit 47 is configured by a monitor, etc., and outputs various images.

The image capturing control unit 46 is configured by a CPU, and controls the entirety of the image capturing apparatus 1. The image capturing control unit 46 generates data of a reconstructed image from a light field image that is captured in a case in which the micro-lens array 31 is mounted. Processing by the image capturing control unit 46 to generate data of a reconstructed image is hereinafter referred to as reconstruction processing.

More specifically, when the operation unit 44 accepts an operation of designating a distance between the main lens 21 and a surface to be reconstructed (hereinafter referred to as a reconstructed surface), the image capturing control unit 46 sets a single pixel in the reconstructed surface as an attention point. The image capturing control unit 46 calculates which pixel in the image capturing element 41 the light from the attention point is distributed through the main lens 21 and the micro-lens array 31.

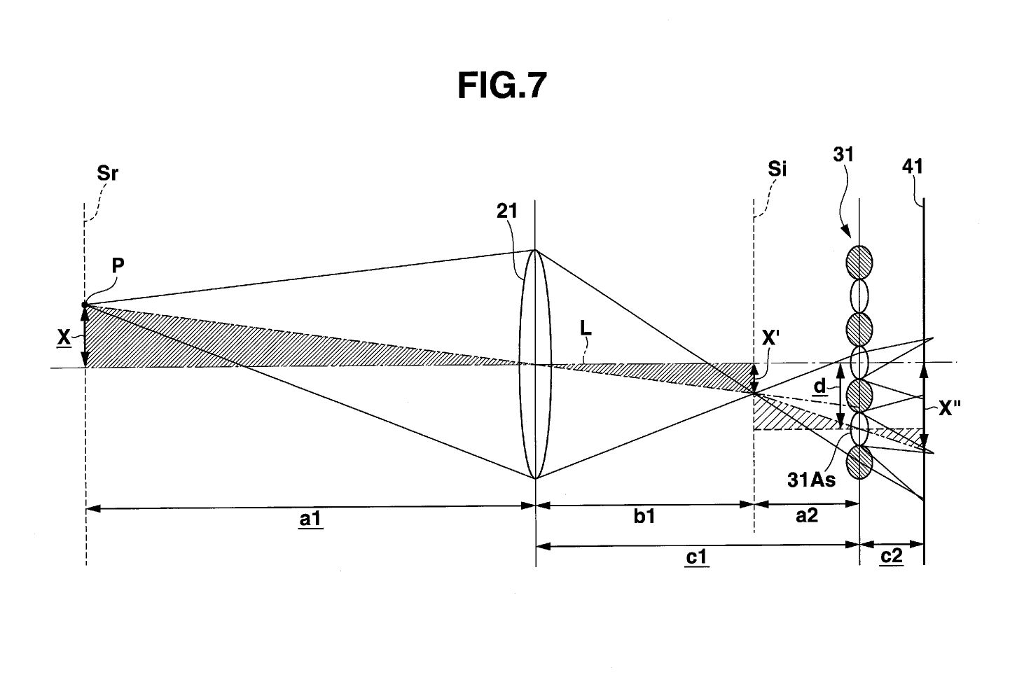

FIG. 7 is a diagram illustrating an aspect, in which the light from the attention point is distributed to the pixel in the image capturing element 41.

In FIG. 7, a central position is a point where a reconstructed surface Sr intersects a straight line L extending from the center of the lens in the optical axis direction, and an attention point P is a point that is separated above at a distance x from the central position. Here, descriptions are provided for an aspect, in which the light from the attention point P enters a micro lens 31As that composes the micro lenses 31A, and the light is then distributed to a pixel in the image capturing element 41.

Each distance in FIG. 7 is defined as follows.

a1: a distance between the main lens 21 and the reconstructed surface Sr.

b1: a main lens imaging distance (a distance between the main lens 21 and an imaging surface Si forming an image from the main lens 21).

c1: a distance between the main lens 21 and the micro-lens array 31.

a2: a distance between the micro-lens array 31 and the imaging surface Si forming an image from the main lens 21.

c2: a distance between the micro-lens array 31 and the image capturing element 41.

d: a distance between the straight line L and the center of the micro lens 31As.

x′: a distance between the focal point of the main lens 21 and the straight line L.

x″: a distance between the straight line L and a position where the distributed light arrives at the image capturing element 41.

The focal distance of the main lens 21 is LML-f. The distances x, a1, c1, c2 and d, which are underlined elements in FIG. 7, are predetermined. Each distance described above indicates the shortest distance.

In this case, the distances b1, a2, x′ and x″, which are not predetermined, are shown by Equations (1) to (4) as follows by using lens equations.

b1=(a1−LML-f)/(a1*LML-f) (1)

a2=c1−b1 (2)

x′=x*b1/a1 (3)

x″=(d−x′)*c2/a2+d (4)

According to Equation (4), the light from the attention point P enters the micro lens 31As, and is distributed to a pixel corresponding to the distance x″ in the image capturing element 41.

The image capturing control unit 46 calculates positions of pixels, to which the light from the attention point P is distributed by the micro lenses, respectively, and calculates an average of pixel values of these positions, thereby determining a pixel value of the attention point P.

The image capturing control unit 46 sets each pixel of a reconstructed image as an attention point, and executes the calculations described above, thereby generating data of the reconstructed image.

After the main lens unit 2 and the micro-lens array unit 3 are mounted to the image capturing unit 4, and while adjusting the position of the principal plane of the main lens 21, the image capturing control unit 46 calculates sizes of the micro lens blurs in a range of object distances from the shortest photographing distance to infinity, and calculates a position of the principal plane of the main lens 21, in which the average of the sizes of the micro lens blurs is the smallest (this position is hereinafter also referred to as an optimal position).

The image capturing control unit 46 may calculate an optimal position of the main lens 21 in an arbitrary range of object distances designated by the user. Detailed descriptions are hereinafter provided for processing of calculating a size of a micro lens blur (hereinafter also referred to as a blur size).

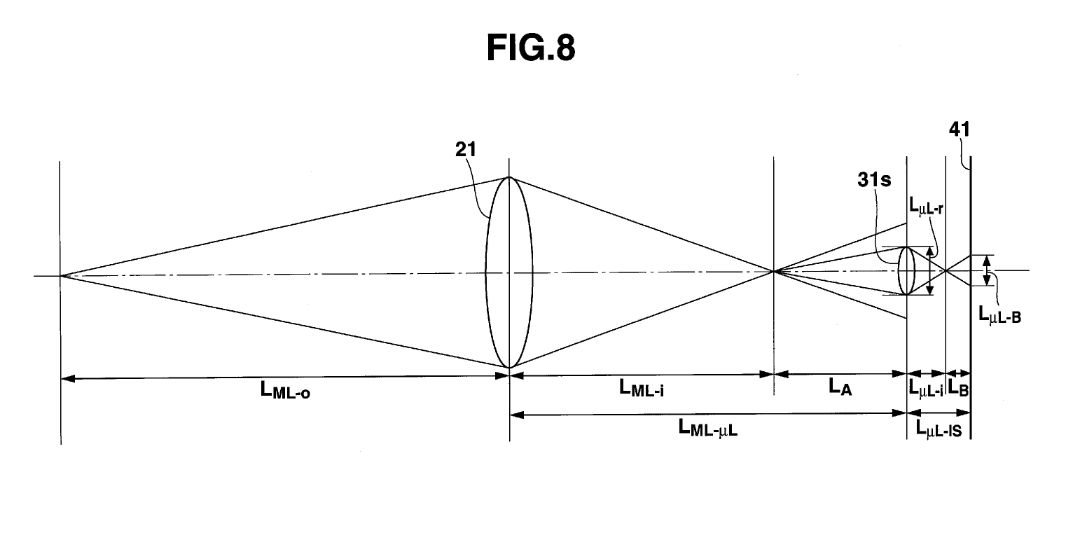

FIG. 8 is a diagram for illustrating calculation of a size of a micro lens blur.

In FIG. 8, for the purpose of calculating a size of a micro lens blur, each distance in the optical system is defined as follows. In FIG. 8, a particular micro lens 31s is taken as an example of the micro lenses that compose the micro-lens array 31, and a size of a micro lens blur of the micro lens 31s is calculated.

LML-f: a main lens focal distance.

LML-O: a main lens object distance (a distance between the main lens 21 and an object).

LML-i: a main lens imaging distance.

LML-μL: a distance between the main lens 21 and the micro lens 31s.

LA: a distance between the focal position of the main lens 21 and the micro lens 31s.

LμL-f: a micro-lens focal distance.

LμL-i: a micro-lens imaging distance (a distance between the micro lens 31s and the focal point of the micro lens 31s).

LμL-IS: a distance between the micro lens 31s and the image capturing element 41.

LB: a distance between the focal point of the micro lens 31s and the image capturing element 41.

LμL-B: a blur size of the micro lens 31s.

LμL-r: an effective diameter of the micro lens 31s.

Here, LML-f, LμL-f and LμL-r are predetermined. Upon mounting the micro-lens array unit 3 to the image capturing unit 4, the image capturing control unit 46 calculates a distance LμL-IS between the micro lens 31s and the image capturing element 41 according to Equation (5) by using the flange back (flange focus) LFB and the micro-lens inside distance LμLi, and stores a calculated value into the image capturing storage unit 45.

LμL-IS=LFB−LμLi (5)

When capturing an image, the image capturing control unit 46 calculates the blur size LμL-B of the micro lens 31s, while changing the distances LML-O and LML-μL.

In other words, the image capturing control unit 46 calculates the main lens imaging distance LML-i according to Equation (6) as follows by using LML-O and LML-f.

LML-i=(LML-O−LML-f)/(LML-O*LML-f) (6)

Subsequently, the image capturing control unit 46 calculates the distance LA between the focal position of the main lens 21 and the micro lens 31s according to Equation (7) as follows by using LML-i and LML-μL.

LA=LML-μL−LML-i (7)

Subsequently, the image capturing control unit 46 calculates the micro-lens imaging distance LμL-i according to Equation (8) as follows by using LμL-f and LA that is calculated by Equation (7).

LμL-i=(LA−LμL-f)/LA*LμL-f (8)

Subsequently, the image capturing control unit 46 calculates the distance LB between the focal point of the micro lens 31s and the image capturing element 41 according to Equation (9) by using LμL-IS that is calculated by Equation (5) and LμLi that is calculated by Equation (8).

LB=LμL-IS−LμL-i (9)

Subsequently, the image capturing control unit 46 calculates the blur size of the micro lens 31s according to Equation (10) by using LμL-r that is predetermined, LμL-i that is calculated by Equation (8), and LB that is calculated by Equation (9).

LμL-B=LμL-r*(LB/LμL-i) (10)

According to the calculations described above, the image capturing control unit 46 calculates an average by adding the blur sizes LμL-B of all the micro lenses for each LML-O. The image capturing control unit 46 identifies LML-O of a case in which the average value of the blur sizes is the smallest, and adjusts the main lens 21 to the position of the identified LML-O. Regarding a distance from the position of the principal plane of the main lens 21 with the focal plane thereof being in infinity to the optimal position thus calculated (a main lens adjustment distance), the image capturing control unit 46 stores the distance into the image capturing storage unit 45 in association with identification information for identifying the micro-lens array unit 3. By doing this way, even in a case in which the micro-lens array unit 3 is demounted from the image capturing unit 4 and mounted thereto again, the position of the main lens 21 can be adjusted, based on the main lens adjustment distance stored in the image capturing storage unit 45.

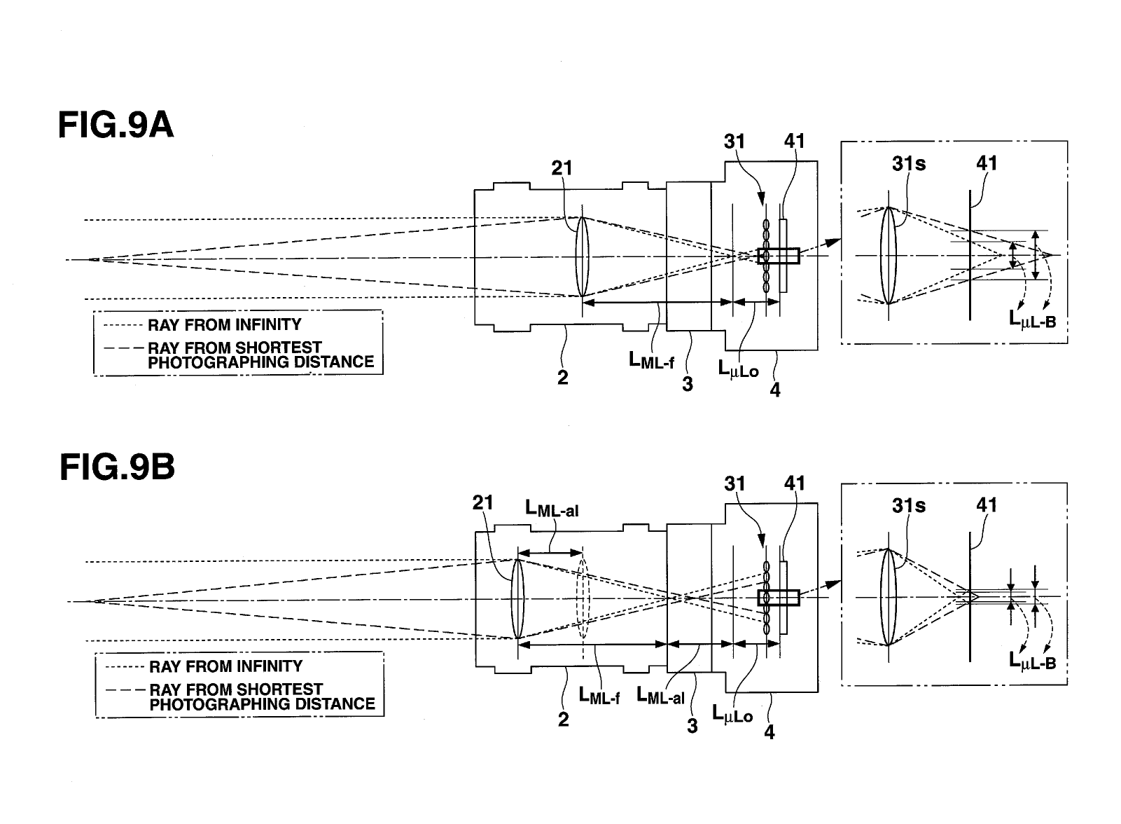

FIGS. 9A and 9B are diagrams showing states before and after adjusting the principal plane of the main lens 21. More specifically, FIG. 9A is a diagram showing a state before adjusting the principal plane of the main lens 21 of the image capturing apparatus 1; and FIG. 9B is a diagram showing a state after adjusting the principal plane of the main lens 21 of the image capturing apparatus 1 for a predetermined distance LML-a1. In FIGS. 9A and 9B, doted lines indicate rays from infinity, and dashed lines indicate rays from the shortest photographing distance. Here, a micro lens blur of the micro lens 31s is taken as an example for description.

FIGS. 9A and 9B each show an enlarged view of the micro lens 31s and the image capturing element 41. As shown in the enlarged views, it can be confirmed that a blur size after adjustment is smaller than a blur size before adjustment. By this adjustment, for example, satisfactory reconstruction is possible in a range of object distances from the shortest photographing distance to infinity.

Based on the focal distance LML-f of the main lens 21 stored in the lens storage unit 25, the micro-lens outside distance LμLo, the micro-lens inside distance LμLi, the focal distance LμL-f and the micro lens pitch LμLp of each micro-lens stored in the array storage unit 35, and the flange back (flange focus) LFB stored in the image capturing storage unit 45, the image capturing control unit 46 calculates an optimum F-number (FML) of the main lens 21, and adjusts the diaphragm mechanism of the main lens 21, thereby changing the F-number of the main lens 21 to the optimum F-number. Here, the optimum F-number refers to an F-number in a case in which the sub-images formed on the image capturing element 41 by the individual micro lenses are in a mutually bordering size.

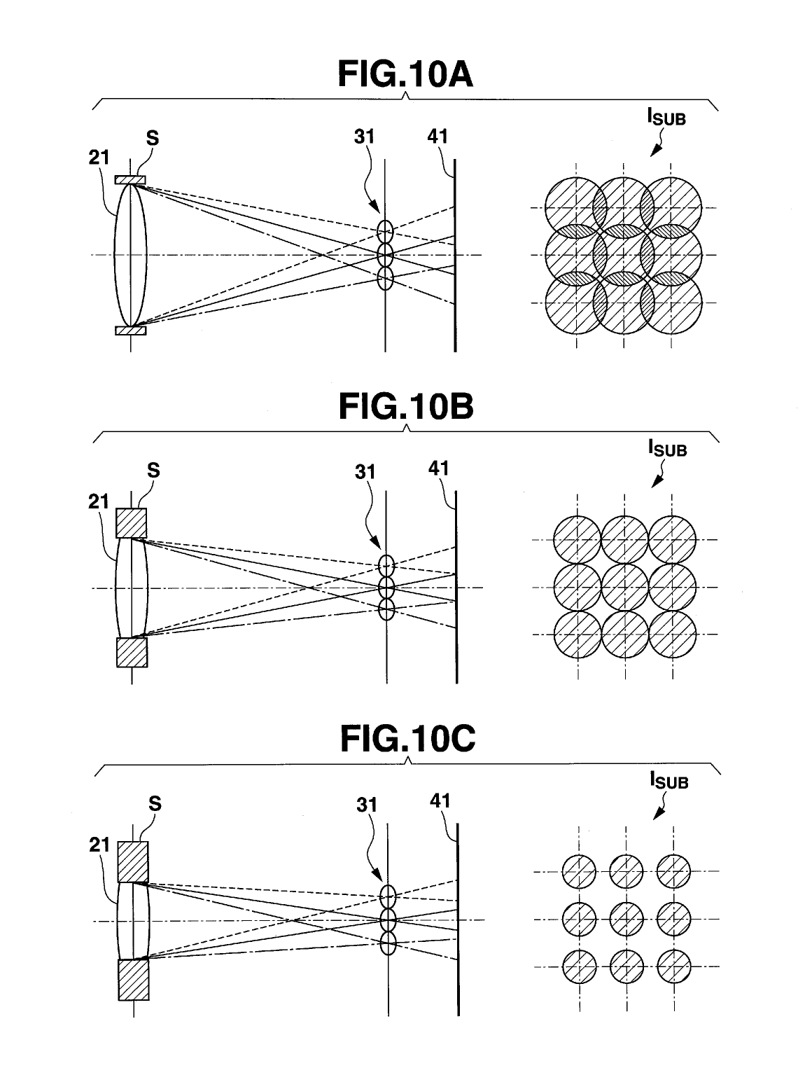

FIGS. 10A to 10C are diagrams showing sub-images that are formed on the image capturing element 41 by the micro lenses in a case in which the diaphragm mechanism of the main lens 21 is adjusted. As shown in FIG. 10A, in a case in which a stop S is broadened by the diaphragm mechanism of the main lens 21, i.e. in a case in which the F-number is reduced, sub-images ISUB formed on the image capturing element 41 overlap with one another. As shown in FIG. 10C, in a case in which the stop S is narrowed by the diaphragm mechanism of the main lens 21, i.e. in a case in which the F-number is increased, the sub-images ISUB formed on the image capturing element 41 do not overlap with one another; however, an area of the sub-images ISUB is decreased. In contrast, as shown in FIG. 10B, in a case in which the stop S is optimally adjusted by the diaphragm mechanism of the main lens 21, i.e. in a case in which the F-number is an optimum F-number, the sub-images ISUB formed on the image capturing element 41 are in a mutually bordering size.

Detailed descriptions are hereinafter provided for processing of calculating an optimum F-number.

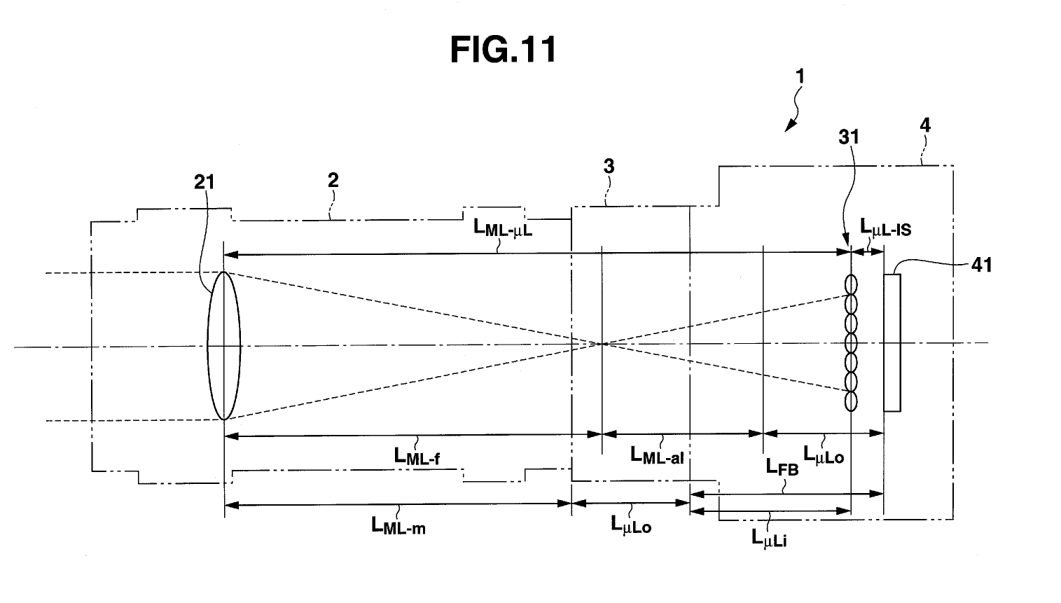

FIG. 11 is a diagram for illustrating calculation of an optimum F-number.

FIG. 11 is described by assuming that distances between components and the micro-lens array 31 are equivalent to the distances between the components and the micro-lens array 31s described above.

Firstly, the image capturing control unit 46 calculates a distance LμL-IS between the micro-lens array 31 and the image capturing element 41 according to Equation (11) by using the flange back (flange focus) LFB and the micro-lens inside distance LμLi. The value, which is calculated according to Equation (5) and stored in the image capturing storage unit 45, may be used as this value.

LμL-IS=LFB−LμLi (11)

Subsequently, the image capturing control unit 46 calculates a distance LML-μL between the main lens 21 and the micro-lens array 31 according to Equation (11) as follows by using LML-f, LML-a1 and LμLo.

LML-μL=LML-f+LML-a1+LμLo−LμL-IS (12)

The lens storage unit 25 may store a distance LML-m between the main lens 21 and the mount as a parameter of the main lens unit 2, and the image capturing control unit 46 may calculate the distance LML-μ between the main lens 21 and the micro-lens array 31 according to Equation (12)′ by using LML-m.

LML-μL=LML-m+LμLo−LμL-Ii (12)′

Subsequently, the image capturing control unit 46 calculates an effective diameter LML-r of the main lens 21 according to Equation (13) by using the micro lens pitch LμLp, LμL-IS calculated according to Equation (11), and LML-μL calculated according to Equation (12).

LML-r=LμLp*LML-μL/LμL-IS (13)

Subsequently, the image capturing control unit 46 calculates an optimum F-number FML of the main lens 21 according to Equation (14) by using LML-f, and LML-r calculated according to Equation (13).

FML=LML-f/LML-r (14)

Subsequently, the image capturing control unit 46 transmits the optimum F-number calculated according to Equation (14) to the lens control unit 26 via the input/output interface 10. The lens control unit 26 causes the drive unit 27 to drive the diaphragm mechanism, based on the optimum F-number received.

The example of adjusting the blur size and the sub-image size by adjusting the principal plane of the main lens 21 and the F-number has been described above. However, the image capturing apparatus 1 may adjust the blur size and the sub-image size by other methods.

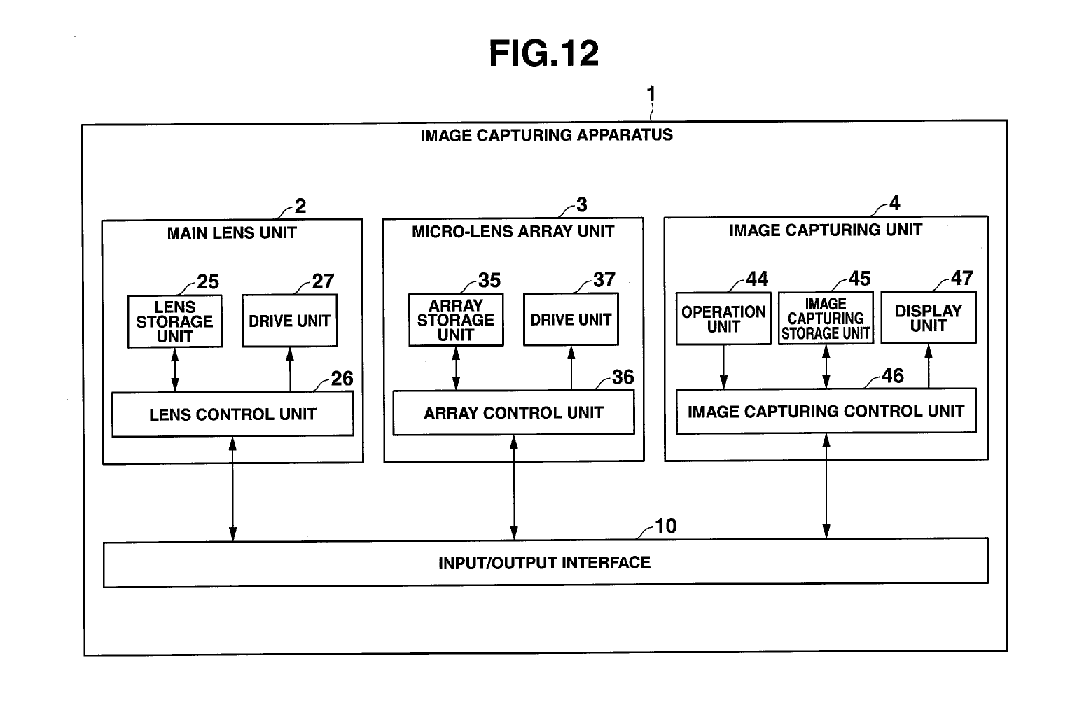

For example, as shown in FIG. 12, a drive unit 37 for sliding the micro-lens array 31 back and forth may be provided to the micro-lens array unit 3, the image capturing control unit 46 may transmit a control signal to the drive unit 37 via the input/output interface 10 and the array control unit 36, and the blur size and the sub-image size may be adjusted by sliding the micro-lens array 31.

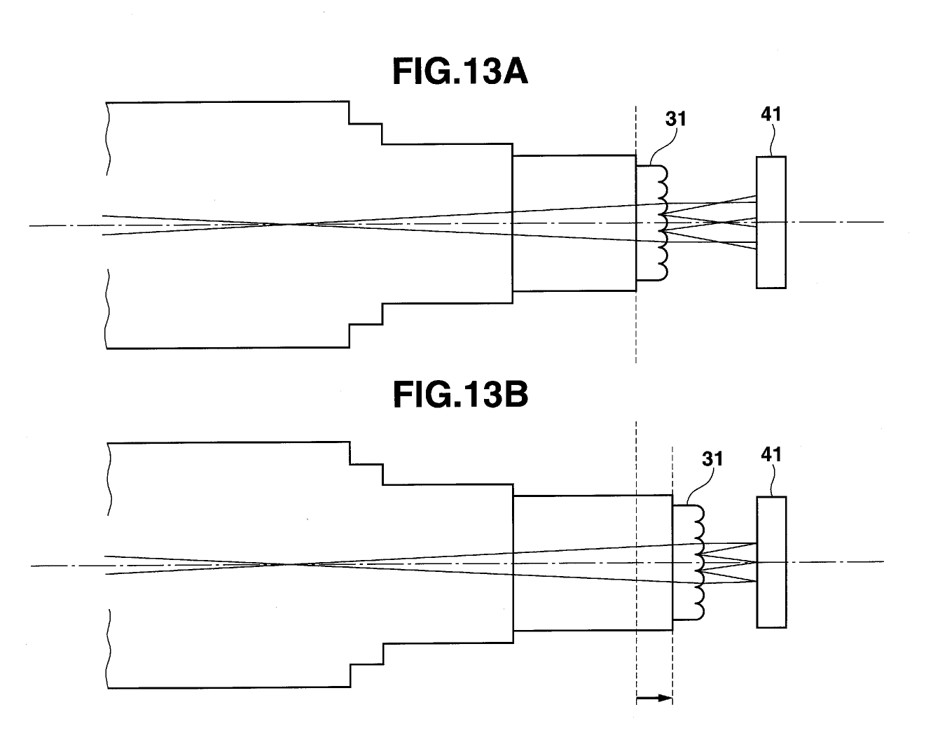

FIGS. 13A and 13B are diagrams showing an example of adjusting the blur size and the sub-image size by adjusting the position of the micro-lens array 31. In other words, FIG. 13A is a diagram showing a state before adjusting the position of the micro-lens array 31; and FIG. 13B is a diagram showing a state after adjusting the position of the micro-lens array 31. In the present example of adjustment, from a state before adjustment, the position of the micro-lens array 31 is moved in a direction toward the image capturing element 41, thereby making it possible to confirm that the light condensed by each micro lens of the micro-lens array 31 forms an image on the surface of the image capturing element 41.

In a case in which a calibration unit 5 is mounted to the main lens unit 2, the image capturing control unit 46 executes calibration.

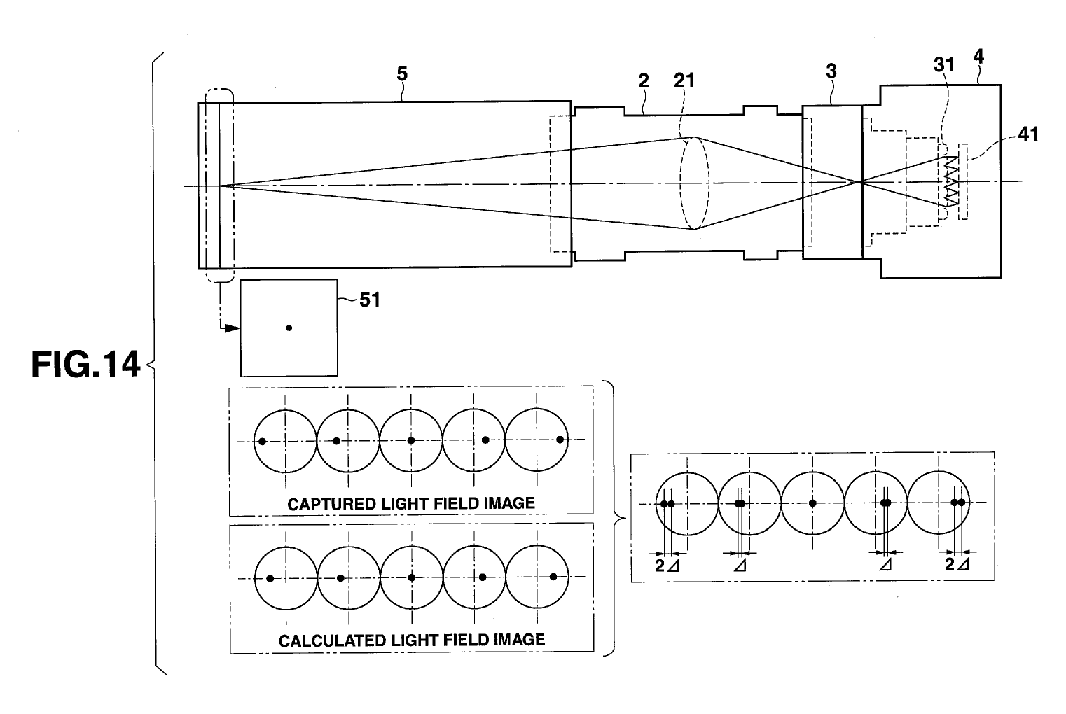

FIG. 14 is a diagram illustrating calibration in the image capturing apparatus 1.

The calibration unit 5 shown in FIG. 14 is a cylindrical member with a specific length, and an image sheet 51 for calibration and a backlight (not shown) are provided to a tip thereof. A point is indicated in the center of the image sheet 51. In a state where the calibration unit 5 is mounted to the tip of the main lens unit 2, the image capturing control unit 46 compares a light field image of the image sheet 51 with a calculated image of the image sheet 51, measures a quantity of deviation therebetween, and executes calibration.

In other words, the image capturing control unit 46 generates a light field image through calculation by assuming that a point exists in the position of the point in the image sheet 51. Subsequently, the image capturing control unit 46 measures a quantity of deviation A of the point, for each sub-image that configures a real light field image, and each sub-image that configures a light field image generated through calculation. Subsequently, based on the quantity of deviation A measured, the image capturing control unit 46 calculates an error of the position of the principal plane of the main lens 21, and stores a correction value for the error into the image capturing storage unit 45 of the image capturing unit 4. In a case in which the image capturing control unit 46 reconstructs a light field image that has been photographed by using the main lens 21 calibrated in this way, the image capturing control unit 46 executes correction, based on the correction value stored in the image capturing storage unit 45.

For example, the calculation results such as the distance between the main lens 21 and the micro-lens array 31 according to Equations (5) to (15) may include calculation errors or optical equations peculiar to the main lens 21 in use. Therefore, an error may occur between the calculated position of the principal plane of the main lens 21 and the actual position of the principal plane of main lens 21. In contrast, since the image capturing apparatus 1 corrects the light field image through calibration by the image capturing control unit 46, definition of the light field image can be made higher definition.

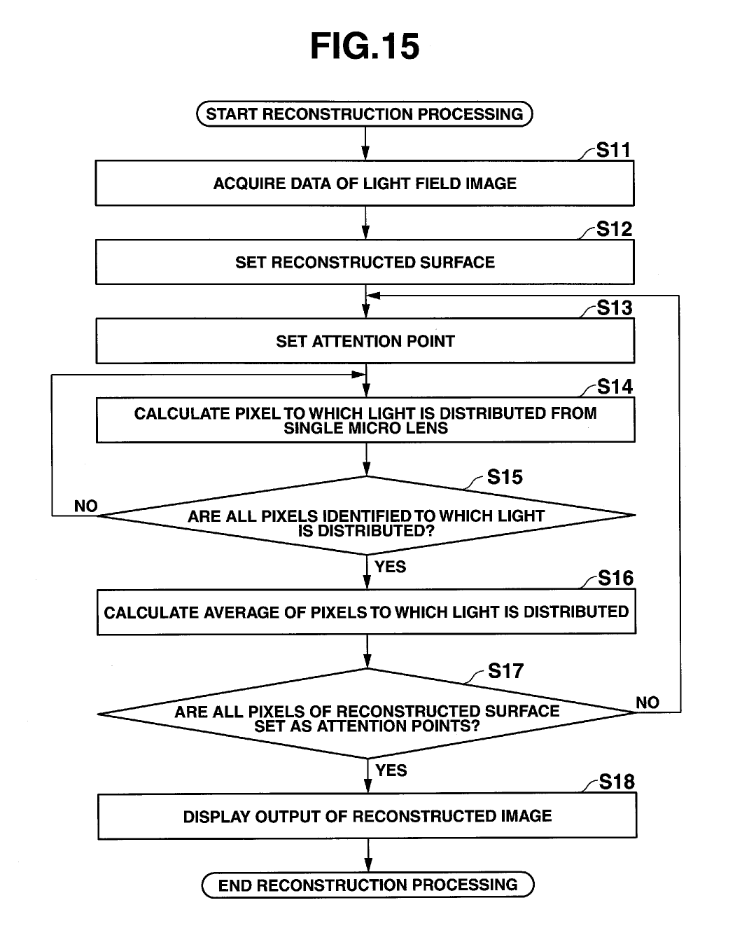

Subsequently, descriptions are provided for a flow of reconstruction processing executed by the image capturing control unit 46. FIG. 15 is a flowchart showing a flow of the reconstruction processing.

In Step S11, the image capturing control unit 46 acquires data of a light field image.

In Step S12, when the operation unit 44 accepts an operation of designating a distance between the main lens 21 and the reconstructed surface, the image capturing control unit 46 sets a surface, which is positioned in the designated distance ahead of the main lens 21, as a reconstructed surface.

In Step S13, the image capturing control unit 46 sets a single pixel, which composed the reconstructed surface, as an attention point P. In a case in which the image capturing control unit 46 sets the single pixel composing the reconstructed surface as the attention point P, a pixel that is not yet set as an attention point P is set as the attention point P.

In Step S14, the image capturing control unit 46 calculates a position of a pixel in the image capturing element 41, to which the light is distributed from a single micro lens. In other words, the image capturing control unit 46 selects a single micro lens from the micro lenses composing the micro-lens array 31, and calculates a position, at which the light from the attention point P having being set in Step S13 enters the selected micro lens and is distributed to the image capturing element 41. The image capturing control unit 46 determines the pixel existing in the calculated position as a pixel to which the light is distributed. In a case in which the image capturing control unit 46 selects a single micro lens, a micro lens that is not yet selected is selected.

In Step S15, the image capturing control unit 46 determines whether all the pixels to which the light is distributed are identified, i.e. whether the processing of calculating positions of pixels to which the light is distributed is executed for all the micro lenses. In a case in which the determination is YES, the image capturing control unit 46 advances the processing the Step S16; and in a case in which the determination is NO, the image capturing control unit 46 returns the processing to Step S14.

In Step S16, the image capturing control unit 46 calculates an average of pixel values of the pixels, to which the light from the attention point P is distributed.

In Step S17, the image capturing control unit 46 determines whether all the pixels configuring the reconstructed surface are set as attention points. In a case in which the determination is YES, the image capturing control unit 46 advances the processing the Step S18; and in a case in which the determination is NO, the image capturing control unit 46 returns the processing to Step S13.

In Step S18, the image capturing control unit 46 displays an output of a reconstructed image.

The configuration and the processing of the image capturing apparatus 1 of the present embodiment have been described above.

In the present embodiment, the image capturing apparatus 1 includes: the image capturing element 41; the main lens 21 that condenses the light from the object in the direction toward the image capturing element 41; and the micro-lens array 31 composed of the plurality of micro lenses being arranged between the image capturing element 41 and the main lens 21, and forming an image on the image capturing element 41 from the light having passed through the main lens 21. The micro-lens array 31 is composed of several types of micro lenses 31A, 31B and 31C with different focal distances. Distribution morphology of the micro lens 31A, which is at least one type of the several types, is different from distribution morphology of the other types of micro lenses 31B and 31C.

Therefore, with the image capturing apparatus 1, by virtue of the several types of micro lenses, micro lens blurs can be suppressed in a range from a short distance to a long distance, and a high-definition reconstructed image can be obtained in a wide distance range.

In the present embodiment, the several types of micro lenses 31A, 31B and 31C are unequally disposed in the micro-lens array 31. In doing do, for example, a larger number of micro lenses corresponding to short distances are arranged in the center of the micro-lens array 31, and a larger number of micro lenses corresponding to long distances are arranged in the periphery of the micro-lens array 31, thereby making it possible to take a picture such that an object in the central portion is accentuated.

In the present embodiment, the image capturing apparatus 1 is configured such that the main lens unit 2 including the main lens 21, the micro-lens array unit 3 including the micro-lens array 31, and the image capturing unit 4 including the image capturing element 41 can be separated.

In this way, since each of the components that configure the image capturing apparatus 1 is unitized so as to be mutually separable, it is possible to provide a light field camera that is more in line with purposes of a user. In other words, since the micro-lens array unit 3 is separable, a user can select a focal distance and a lens pitch of the micro lenses in accordance with the image resolution and the depth resolving power as intended by the user. By selecting the micro-lens array unit 3 in which the quantity of light passing through individual micro lenses is varied, a user of the image capturing apparatus 1 can easily photograph a high dynamic range (HDR) image

In this way, each of the components that configure the image capturing apparatus 1 is unitized, in which the main lens unit 2 is not intended for exclusive use for a light field camera; however, a lens unit that is conventionally used for a single-lens reflex camera and the like can also be used. As a result, a user can introduce the image capturing apparatus 1 more easily. The image capturing unit 4 can be concomitantly used for the image capturing apparatus 1 and a conventional camera, whereby a user can introduce the image capturing apparatus 1 more easily.

The present invention is not limited to the aforementioned embodiment, and modifications, improvements, etc. within a scope that can achieve the object of the present invention are also included in the present invention.

For example, in the embodiment described above, the three types of micro lens 31A, 31B and 31C compose the micro-lens array 31; however, the present invention is not limited thereto. For example, two types of micro lenses, or four or more types of micro lenses may compose the micro-lens array 31.

In the embodiment described above, data of an image captured by the image capturing apparatus 1 itself is employed as data of a light field image that is used when generating data of a reconstructed image; however, the present invention is not particularly limited thereto.

In other words, the image capturing apparatus 1 may generate data of a reconstructed image by using data of a light field image that is captured by another image capturing apparatus or another conventional plenoptic camera.

In other words, the present invention can be applied not only to the image capturing apparatus 1 with an image capturing function, but also to electronic devices in general with a typical image processing function, even without an image capturing function. For example, the present invention can be applied to a personal computer, a printer, a television, a video camera, a navigation device, a cell phone device, a portable game device, etc.

The processing sequence described above can be executed by hardware, and can also be executed by software.

In other words, the hardware configurations shown in FIGS. 6 and 12 are merely an illustrative example, and the present invention is not particularly limited thereto. More specifically, the types of functional blocks employed to realize the aforementioned functions are not particularly limited to the examples in FIGS. 6 and 12, so long as the image capturing apparatus 1 can be provided with the functions enabling the aforementioned processing sequence to be executed as its entirety.

A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by a removable medium 31 (not shown) provided to the image capturing apparatus in FIGS. 6 and 12 and distributed separately from the device main body for supplying the program to a user, but can also be constituted by a storage medium or the like supplied to the user in a state incorporated in the device main body in advance. The removable medium is composed of a magnetic disk (including a floppy disk), an optical disk, a magnetic optical disk, or the like, for example. The optical disk is composed of a CD-ROM (Compact Disk-Read Only Memory), a DVD (Digital Versatile Disk), or the like, for example. The magnetic optical disk is composed of an MD (Mini-Disk) or the like. The recording medium provided to the user in a state incorporated in the main body of the equipment in advance is configured by a hard disk or the like included in the image capturing storage unit 45 in FIGS. 6 and 12, in which the program is recorded.

In the present specification, the steps describing the program recorded in the storage medium include not only the processing executed in a time series following this order, but also processing executed in parallel or individually, which is not necessarily executed in a time series.

Although some embodiments of the present invention have been described above, the embodiments are merely exemplification, and do not limit the technical scope of the present invention. Other various embodiments can be employed for the present invention, and various modifications such as omission and replacement are possible without departing from the sprits of the present invention. Such embodiments and modifications are included in the scope of the invention and the summary described in the present specification, and are included in the invention recited in the claims as well as the equivalent scope thereof.

What is claimed is:

1. An image capturing apparatus, comprising:
an image capturing element;
a main lens that condenses light from an object in a direction toward the image capturing element; and
a micro-lens array that is composed of a plurality of micro lenses being arranged between the image capturing element and the main lens, and forming an image on the image capturing element from the light having passed through the main lens,
wherein the micro-lens array is composed of a plurality of types of micro lenses with different focal distances, and
wherein distribution morphology of at least one type of the plurality of types of micro lenses is different from distribution morphology of other types of the micro lenses.

2. The image capturing apparatus according to claim 1,
wherein the plurality of types of micro lenses are unequally arranged in the micro-lens array.

3. The image capturing apparatus according to claim 1,
wherein a main lens unit including the main lens, a micro-lens array unit including the micro-lens array, and an image capturing unit including the image capturing element are configured so as to be separable.

4. The image capturing apparatus according to claim 1,
wherein the micro-lens array includes a different number of micro lenses for each of the types.

5. An image capturing apparatus that is configured by:
an image capturing unit including an image capturing element;
a main lens unit, which is configured to be detachable from the image capturing unit, and which includes a main lens that condenses light from an object in a direction toward the image capturing element; and
a micro-lens array unit including a micro-lens array that is composed of a plurality of micro lenses, the micro-lens array being detachably arranged between the image capturing unit and the main lens unit, and forming an image on the image capturing element from light having passed through the main lens,
the image capturing apparatus comprising:
a lens position adjustment unit that adjusts a position of the main lens or the micro-lens array by moving the main lens or the micro-lens array to a position where sizes of micro lens blurs are minimized, in a case in which the micro-lens array unit is mounted between the image capturing unit and the main lens unit.

6. The image capturing apparatus according to claim 5,
wherein the lens position adjustment unit calculates sizes of micro lens blurs of micro lenses composing the micro-lens array in an arbitrary object distance range designated by a user, and moves the main lens or the micro-lens array to a position where an average of the sizes of the micro lens blurs is minimized.

7. The image capturing apparatus according to claim 5,
wherein the main lens unit includes a diaphragm mechanism,
the image capturing apparatus further comprising:
a diaphragm mechanism adjustment unit that adjusts the diaphragm mechanism, such that sub-images formed on the image capturing element by the individual micro lenses composing the micro-lens array have a mutually bordering size, in a case in which the micro-lens array unit is mounted between the image capturing unit and the main lens unit.
